(19) United States
(12) Patent Application Publication
(10) Pub. No.: US 2008/0318777 A1
(43) Pub. Date: Dec. 25, 2008

(54) Microbial Formulation and Method of Using the Same to Promote Plant Growth

(75) Inventors: Jian Er LIN, Hong Kong (CN); Shelley Wenwen ZHOU, Hong Kong (CN); Kee Hung CHU, Hong Kong (CN)

Correspondence Address: WILKINSON & GRIST, 6TH FLOOR, PRINCE'S BUILDING, CHATER ROAD, CENTRAL, HONG KONG, CN

(73) Assignee: Ultra Biotech Limited

(21) Appl. No.: 12/141,937

(22) Filed: Jun. 19, 2008

Related U.S. Application Data
(60) Provisional application No. 60/945,149, filed on Jun. 20, 2007.

(51) Int. Cl. A01N 63/00

(52) U.S. Cl. 504/117

(57) ABSTRACT

A plant growth promoting composition includes beneficial microbes and microbial activators. The beneficial microbes may include Bacillus spp., Azotobacter spp., Trichoderma spp., Saccharomyces spp., or combinations of these.

The present application claims priority to U.S. Provisional Application Ser. No. 60/945,149, entitled “Microbial Formulation and Method of Using the Same to Promote Plant Growth,” which was filed on Jun. 20, 2007, the content of which is incorporated herein by reference.

### BACKGROUND

Excess amounts of chemical fertilizers have been used in agriculture worldwide to provide nutrients to support plant growth. While chemical fertilizers have offered benefits to modern agriculture, it has been observed that the texture and quality of agricultural soil degrades with the increased use of chemical fertilizers. The overuse of chemical fertilizers has caused soil compaction and erosion, and has resulted in both lower production yield and lower use efficiency of fertilizers. Therefore, the sustainable use of agricultural lands is of particular interest, and the excessive use of chemical fertilizers is also of interest to food safety and environmental protection.

Recent research on biological fertilizers using microbes has shown promise. For example, use of microbes in fertilizers can aid in replenishing and maintaining long-term soil fertility by providing good soil biological activity; suppressing pathogenic soil organisms; stimulating microbial activity around the root system to increase the plant mass and to improve plant health; helping to release essential nutrients such as nitrogen, phosphate and potassium; improving soil porosity, water holding and aeration; and reducing soil compaction and erosion.

Nonetheless, technical difficulties exist that have to be overcome in order to harness the potential benefits offered by the microbial fertilizers. First, stability is required for the microbial products to be commercially feasible. Thus, advanced manufacturing and formulation techniques of producing stable microbes are desirable. Second, maintaining and growing the microbial population after they are added to the soil are challenging, and improved technologies are needed to ensure the microbes are functional in soil. Third, formulating the microbes with other fertilizer components, such as organic and chemical fertilizers, is desirable. Therefore, new microbial formulation technology is needed to ensure the compatibility of the microbe-containing fertilizer products.

### SUMMARY

According to one aspect, a plant growth promoting composition includes beneficial microbes and microbial activators. The beneficial microbes may be selected from the group consisting of Bacillus spp., Azotobacter spp., Trichoderma spp., and Saccharomyces spp. The microbial activators may be selected from processed yeast product such as yeast autolysates, humic materials, seaweed extract, starch, amino acids, and/or trace elements such as Zn, Fe, Cu, Mn, B, and Mo.

According to another aspect, a plant growth promoting composition includes beneficial microbes, microbial activators and an organic fertilizer.

According to a further aspect, a plant growth promoting composition includes beneficial microbes, microbial activators, an organic fertilizer and a chemical fertilizer.

According to another aspect, a method of making a plant growth promoting composition includes grinding and mixing raw materials, drying the ground and mixed raw materials at a temperature of from 80 to 300° C. to form granulation products, mixing the granulation products with microbes and molasses, and forming said composition by drying the ground and mixed granulation products at a temperature no higher than 80° C.

According to yet another aspect, a method of promoting plant growth includes applying a plant growth promoting composition. The plant growth promoting composition includes beneficial microbes and microbial activators.

### BRIEF DESCRIPTION OF THE DRAWINGS

FIG. 1A depicts the root dry weight of test plants at day 38 having applied a Trichoderma microbe.

FIG. 1B depicts the shoot dry weight of test plants at day 38 having applied a Trichoderma microbe.

FIG. 2A depicts the average height of test plants at day 41 having applied a microbial blend.

FIG. 2B depicts the average canopy of test plants at day 41 having applied a microbial blend.

FIG. 2C depicts the average stem diameter of test plants at day 41 having applied a microbial blend.

FIG. 2D depicts the average chlorophyll index of test plants at day 41 having applied a microbial blend.

FIG. 3A depicts the canopies of test plants at day 35 having applied a Trichoderma microbe and various microbe activators.

FIG. 3B depicts the stem diameters of test plants at day 35 having applied a Trichoderma microbe and various microbe activators.

FIG. 3C depicts the dry shoot weights of test plants at day 35 having applied a Trichoderma microbe and various microbe activators.

FIG. 3D depicts the dry root weights of test plants at day 35 having applied a Trichoderma microbe and various microbe activators.

FIG. 4A depicts the heights of test plants at day 21 having applied a Bacillus substilis microbe and various microbe activators.

FIG. 4B depicts the canopies of test plants at day 21 having applied a Bacillus substilis microbe and various microbe activators.

FIG. 4C depicts the dry shoot weights of test plants at day 21 having applied a Bacillus substilis microbe and various microbe activators.

FIG. 4D depicts the dry root weights of test plants at day 21 having applied a Bacillus substilis microbe and various microbe activators.

FIG. 5A depicts the average height of test plants at day 41 having applied the microbial blend of FIG. 2A and various microbe activators.

FIG. 5B depicts the average canopy of test plants at day 41 having applied the microbial blend of FIG. 2B and various microbe activators.

FIG. 5C depicts the average stem diameter of test plants at day 41 having applied the microbial blend of FIG. 2C and various microbe activators.

FIG. 5D depicts the average chlorophyll index of test plants at day 41 having applied the microbial blend of FIG. 2D and various microbe activators.

FIG. 6A depicts the height of test plants having applied the plant growth promoting composition with an organic fertilizer.

FIG. 6B depicts the crown diameter of test plants having applied the plant growth promoting composition with an organic fertilizer.

FIG. 6C depicts the root biomass of test plants having applied the plant growth promoting composition with an organic fertilizer.

FIG. 6D depicts the shoot biomass of test plants having applied the plant growth promoting composition with an organic fertilizer.

FIG. 7A depicts the shoot biomass of a plant having applied a first sample of the plant growth promotion composition and organic fertilizer with chemical fertilizers.

FIG. 7B depicts the shoot biomass of a plant having applied a second sample of the plant growth promotion composition and organic fertilizer with chemical fertilizers.

FIG. 7C depicts the shoot biomass of a plant having applied a third sample of the plant growth promotion composition and organic fertilizer with chemical fertilizers.

FIG. 8 depicts the stability of selected microbes in chemical fertilizer solutions.

FIG. 9A depicts the first step of a granulation process for producing the plant growth promoting composition.

FIG. 9B depicts the second step of a granulation process for producing the plant growth promoting composition.

### DETAILED DESCRIPTION

Reference will now be made in detail to a particular embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below, and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims. In addition, improvements and modifications which may become apparent to persons of ordinary skill in the art after reading this disclosure, the drawings, and the appended claims are deemed within the spirit and scope of the present invention.

A plant growth promoting composition may include beneficial microbes and microbial activators. Inert ingredients, such as fillers, may also be incorporated into the composition.

The beneficial microbes may include Bacillus spp., Azotobacter spp., Trichoderma spp. and Saccharomyces spp. More specifically, the beneficial microbes may include Bacillus polymyxa, Bacillus subtilis, Azotobacter chroococcum, Trichoderma harzianum, and Saccharomyces cerevisiae. Other beneficial microbes may also be selected to achieve the designated plant growth promoting function, and may contain bacteria, fungi, and/or yeasts to provide microbial diversity and balance. Preferably, the beneficial microbes are soil isolates that can survive soil conditions.

The microbial activators may include enzyme precursors, microbial metabolites, organic acid, carbohydrate, enzymes, and/or trace elements. For example, the microbial activators may include processed yeast product such as yeast autolysates, humic materials, seaweed extract, starch, amino acids, and/or trace elements such as Zn, Fe, Cu, Mn, B, and Mo. The microbial activators may be selected, formulated and applied to enhance the efficiency of the beneficial microbes to be used in promoting plant growth. Specifically, the microbial activators are configured to improve metabolism of microorganisms, to stimulate their growth, and to increase the production of biochemicals.

The plant growth promoting composition may include from about 1 to about 50 weight percent (wt %) of beneficial microbes, preferably from about 1 to about 20 wt %, and more preferably from about 1 to about 10 wt %. The plant growth promoting composition may include from about 50 to about 99 wt % of microbial activators, preferably from about 80 to about 99 wt %, and more preferably from about 90 to about 99 wt %.

In another embodiment, the plant growth promoting composition may include beneficial microbes, microbial activators, and an organic fertilizer. The beneficial microbes and microbial activators may be the same as those already described above. The organic fertilizer may include manure compost, raw manure, and/or organic wastes from various food and/or bio-fuel processes. The organic fertilizer may also include other organic materials known to one skilled in the art that may promote plant growth.

In this embodiment, the plant growth promoting composition may include from about 1 to about 20 wt % of beneficial microbes, preferably from about 1 to about 10 wt %, and more preferably from about 1 to about 5 wt %. The plant growth promoting composition may include from about 5 to about 50 wt % of microbial activators, preferably from about 10 to about 40 wt %, and more preferably from about 25 to about 35 wt %. The plant growth promoting composition may include from about 30 to about 94 wt % of organic fertilizers, preferably from about 50 to about 89 wt %, and more preferably from about 60 to about 74 wt %.

In yet another embodiment, the plant growth promoting composition may include beneficial microbes, microbial activators, an organic fertilizer, and a chemical fertilizer. The beneficial microbes, the microbial activators and the organic fertilizer may be the same as those already described above. The chemical fertilizers may include various chemicals that can provide nutrients of nitrogen, phosphate, and/or potassium to support plant growth. For example, the chemical fertilizer may include urea, calcium phosphate, potassium phosphate, and/or blended nitrogen-phosphate-potassium (NPK) fertilizers. The chemical fertilizer may also include other materials known in the art.

In this embodiment, the plant growth promoting composition may include from about 0.1 to about 10 wt % of beneficial microbes, preferably from about 0.1 to about 5 wt %. The plant growth promoting composition may include from about 2 to about 50 wt % of microbial activators, preferably from about 5 to about 50 wt %, and more preferably from about 5 to about 40 wt %. The plant growth promoting composition may include from about 5 to about 92.9 wt % of organic fertilizers, preferably from about 10 to about 89.9 wt %, and more preferably from about 10 to about 74 wt %. The plant growth promoting composition may include from about 5 to about 92.9 wt % of chemical fertilizers, preferably from about 5 to about 84.9 wt %, and more preferably from about 20 to about 84.9 wt %.

The composition of any of the embodiments described above may be produced in the form of a powder, a granule, a pellet or a liquid. The composition may also be used for basal and/or top dressing applications to promote plant growth.

A method of promoting plant growth includes applying the plant growth promoting composition. The plant growth promoting composition may be applied alone, in combination with an organic fertilizer, a chemical fertilizer, or combinations thereof. The plant growth promoting composition is preferably configured to enhance efficiency of organic fertilizers and/or chemical fertilizers, and to improve the soil texture and quality for sustainable use of the agricultural land. The composition is also preferably configured to reduce plant pathogens.

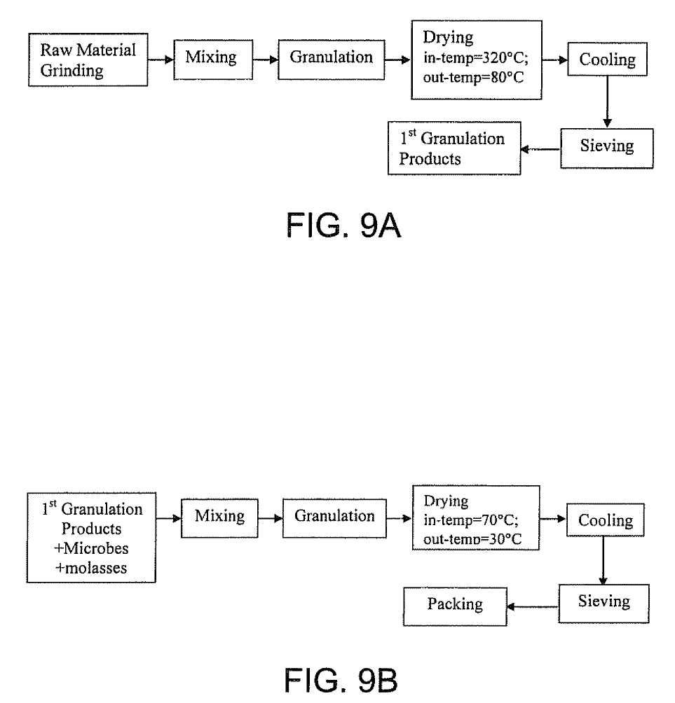

A method of making a plant growth promoting composition includes grinding and mixing raw materials, drying the ground and mixed raw materials at a temperature of from 80 to 300° C. to form granulation products, mixing the granulation products with microbes and molasses, and forming said composition by drying the mixed granulation products at a temperature no higher than 80° C. A granulation process may be used to produce a plant growth promoting composition that includes beneficial microbes, microbial activators, organic fertilizers and/or chemical fertilizers. In the first step of granulation, the granules formed may be dried at a high temperature, while in the second step of granulation, low-temperature drying may be utilized, as depicted in FIGS. 9A and 9B. Raw materials commonly known to one skilled in the art for making fertilizers may be used, such as those already described for the organic or chemical fertilizer.

Reference will now be made in detail to the preferred embodiments, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the plant growth promoting composition is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

### EXAMPLES

### Example 1

### Effect of Selected Trichoderma Strain

In this example, a pot test was performed to show a selected Trichoderma microbe could enhance the efficiency of organic fertilizers. Sandy loam was used as the potting matrix, tomato (Lycopersicon esculentum) was used as the test plant, and compost was used as the organic fertilizer (0.5% w/w). The pot size was 10 cm in both diameter and height. The Trichoderma microbe at four dosages (i.e., 10¹, 10⁴, 10⁶ and 10⁷ CFU/g soil, designated as dosages 1, 2, 3, and 4, respectively) were added to the potting mix before transplant of the tomato seedlings. The soil control sample was an un-inoculated seedling where only organic fertilizer was added.

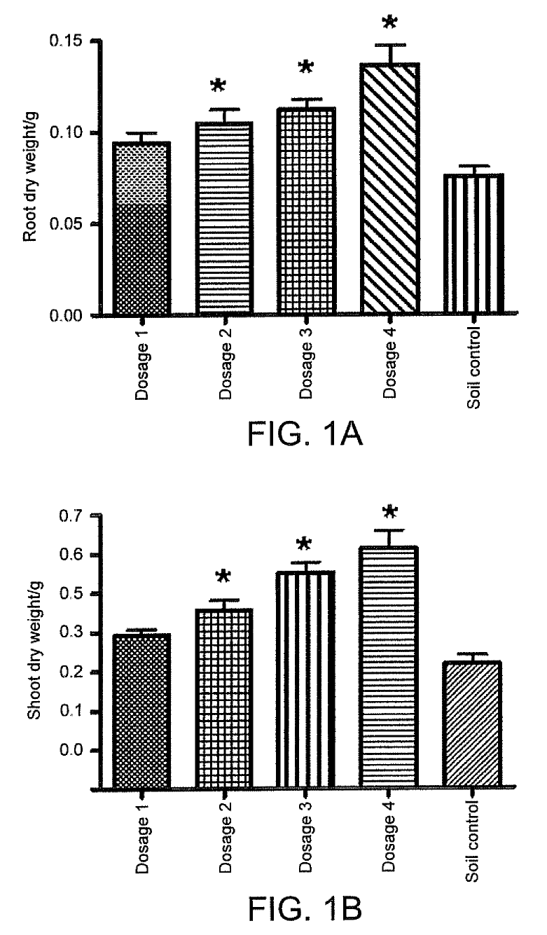

Plant biomass in the form of root dry weight and shoot dry weight were measured at harvest (Day 38), as depicted in FIGS. 1A and 1B. According to FIG. 1A, the plant biomass of the roots of the inoculated seedlings (dosages 2, 3 and 4) was significantly higher than that of the un-inoculated seedlings (soil control). The root dry weight increased with the increase of microbial dosage. Similarly, according to FIG. 1B, the plant biomass of the shoots of the inoculated seedlings (dosages 2, 3 and 4) was also significantly higher than the un-inoculated seedlings (soil control). The shoot dry weight increased with the increase of microbial dosage.

Consequently, this example indicated that the Trichoderma microbe significantly promoted the efficiency of organic fertilizer, and the effect exhibited a dose-response relationship.

### Example 2

### Effect of Microbial blend

In this example, a pot test was performed to show a selected microbial blend, which contained Bacillus polymyxa, Bacillus subtilis, Trichoderma harzianum, and Saccharomyces cerevisiae, could promote the efficiency of organic fertilizers. Sandy loam was used as the potting matrix, tomato (Lycopersicon esculentum) was used as the test plant, and compost was used as the organic fertilizer (0.5% w/w). The pot size was 10 cm in both diameter and height. The microbial blend at three dosages (i.e., 10², 10³, and 10⁴ CFU/g soil, designated as M1, M2, and M3, respectively) was added to the potting mix before transplant of the tomato seedlings. The control sample (Ctrl) was an un-inoculated seedling where only organic fertilizer was added.

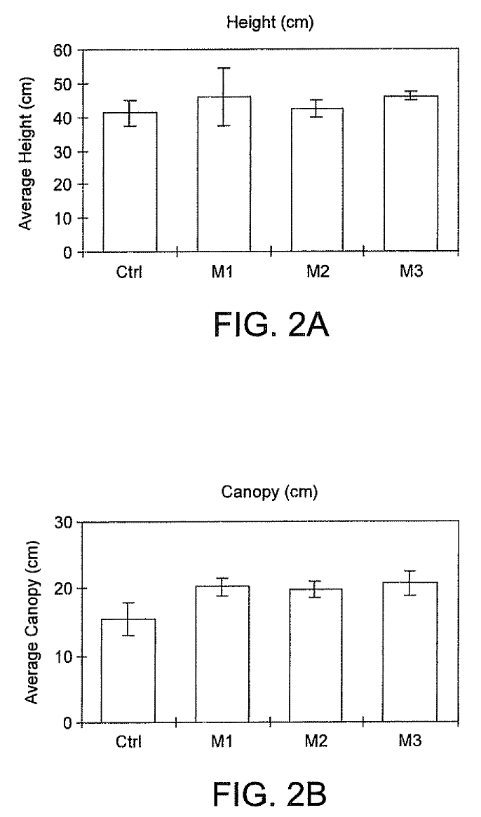

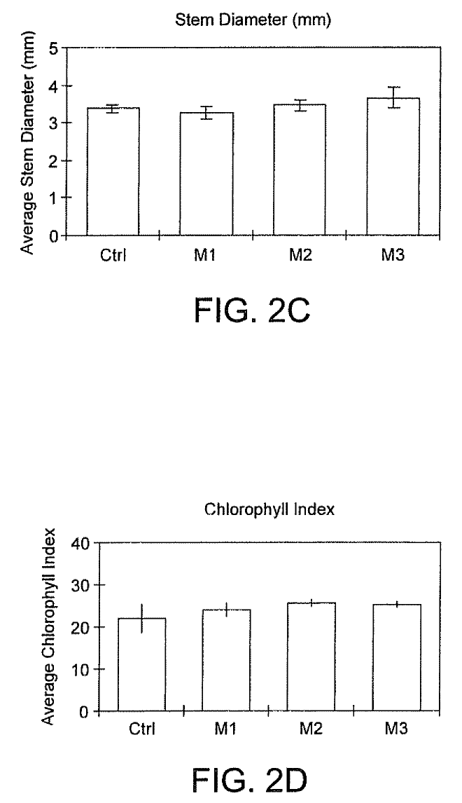

Plant height, canopy, stem size and chlorophyll index were measured at day 41, recorded in Tables 1 to 4 and depicted in FIGS. 2A to 2D. According to FIG. 2B, the canopy of the inoculated seedlings (M1, M2 and M3) was significantly higher than that of the un-inoculated seedlings (Ctrl). Similarly, according to FIG. 2D, the chlorophyll index of the inoculated seedlings (M2) was also significantly higher than that of the un-inoculated seedlings (Ctrl). The plant height of the inoculated seedlings (M1 and M3 of FIG. 2A) and the stem diameter of the inoculated seedlings (M2 and M3 of FIG. 2C) were also significantly higher than those of the un-inoculated seedlings (Ctrl). Consequently, this example indicated that the selected microbial blend significantly promoted the efficiency of organic fertilizer.

TABLE 1
Average height of plants at day 41 having applied a microbial blend

| | Height (cm) | | | | | | |
|---|---|---|---|---|---|---|---|
| Sample ID | #1 | #2 | #3 | #4 | #5 | Average | SD |
| Ctrl | 39.5 | 43.5 | 44.5 | 43.0 | 35.5 | 41.2 | 3.7 |
| M₁ | 42.5 | 40.0 | 40.5 | 45.0 | 60.5 | 45.7 | 8.5 |
| M₂ | 45.0 | 42.0 | 43.5 | 43.0 | 38.5 | 42.4 | 2.4 |
| M₃ | 46.0 | 45.5 | 45.5 | 45.5 | 48.0 | 46.1 | 1.1 |

TABLE 2
Average canopy of plants at day 41 having applied a microbial blend

| | Canopy (cm) | | | | | | |
|---|---|---|---|---|---|---|---|
| Sample ID | #1 | #2 | #3 | #4 | #5 | Average | SD |

| | | | | | | | |
|---|---|---|---|---|---|---|---|
| Ctrl | 13.0 | 17.0 | 18.5 | 16.0 | 13.0 | 15.5 | 2.4 |
| M₁ | 20.5 | 19.0 | 19.5 | 20.0 | 22.5 | 20.3 | 1.4 |
| M₂ | 20.0 | 20.5 | 21.4 | 19.5 | 18.0 | 19.9 | 1.3 |
| M₃ | 18.5 | 19.5 | 21.5 | 23.0 | 21.0 | 20.7 | 1.8 |

TABLE 3
Average stem diameter of plants at day 41 having applied a
microbial blend

| | Stem (mm) | | | | | | |
|---|---|---|---|---|---|---|---|
| Sample ID | #1 | #2 | #3 | #4 | #5 | Average | SD |
| Ctrl | 3.5 | 3.3 | 3.3 | 3.5 | 3.3 | 3.4 | 0.1 |
| M₁ | 3.2 | 3.0 | 3.3 | 3.5 | 3.3 | 3.3 | 0.2 |
| M₂ | 3.6 | 3.3 | 3.4 | 3.7 | 3.4 | 3.5 | 0.1 |
| M₃ | 3.4 | 3.8 | 3.7 | 4.0 | 3.3 | 3.7 | 0.3 |

TABLE 4
Average chlorophyll index of plants at day 41 having applied a
microbial blend

| | Chlorophyll Index | | | | | | |
|---|---|---|---|---|---|---|---|
| Sample ID | #1 | #2 | #3 | #4 | #5 | Average | SD |
| Ctrl | 16.0 | 23.1 | 22.7 | 23.4 | 24.6 | 22.0 | 3.4 |
| M₁ | 25.5 | 21.8 | 23.8 | 25.6 | 23.2 | 24.0 | 1.6 |
| M₂ | 25.7 | 26.6 | 25.9 | 25.5 | 24.3 | 25.6 | 0.8 |
| M₃ | 24.8 | 25.6 | 24.4 | 25.2 | 26.2 | 25.2 | 0.7 |

### Example 3

### Effects of Microbial Activator on Trichoderma Strain

In this example, the Trichoderma microbe supplemented with different microbial activators was applied to tomato seedlings in a pot test to show its effectiveness. The experimental set up was similar to that described in Example 1. Table 5 summarizes the composition of various activator formulations used in this example, which included yeast autolysates, humic powder and micronutrients with amino acids.

TABLE 5
Composition of Activator Formulations on Trichoderma

| | Substrate (g/pot) | | | |
|---|---|---|---|---|
| | | Yeast | Humic | Micronutrients + |
| Treatment # | Microbes | Autolysates | Powder | Amino Acid |
| P0 | 0.5 | — | — | — |
| P2-0.2 | 0.5 | 0.2 | — | — |
| P3-8 | 0.5 | — | 8 | — |
| P4-0.05 | 0.5 | — | — | 0.05 |
| P9-0.2 | 0.5 | 0.2 | 4 | — |

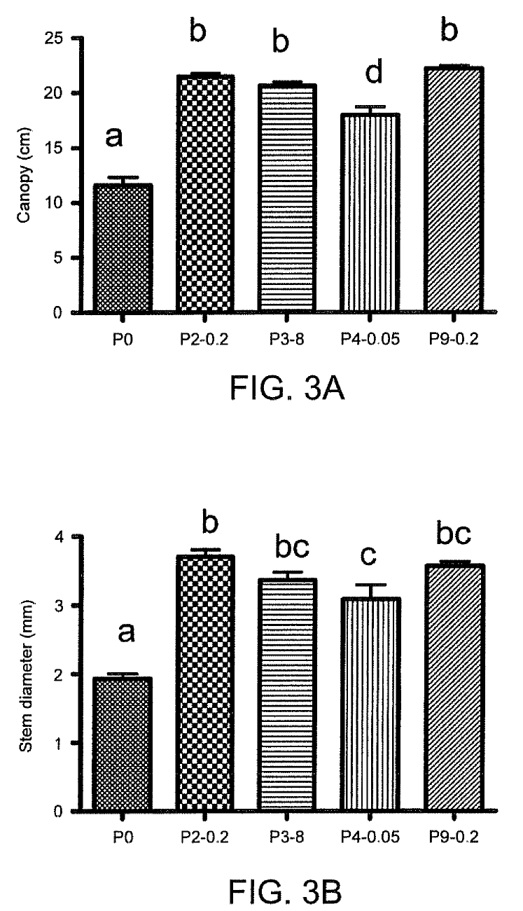

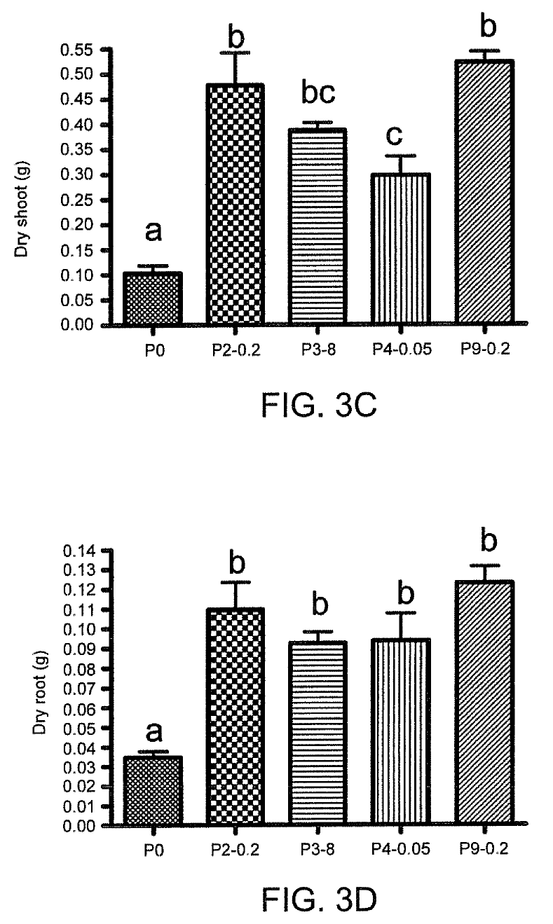

Plant height, stem size, dry shoot weight and dry root weight were measured at day 35, as depicted in FIGS. 3A to 3D. As shown, microbes supplemented with yeast autolysates, humic powder, and/or micronutrients (Treatments P2-0.2, P3-8, P4-0.05, and P9-0.2) exhibited significantly higher values in terms of plant canopy, stem diameter, dry root weight and dry shoot weight than did the treatment with the microbes alone (Treatment P0).

Consequently, this example indicated that the selected microbial activator formulations significantly improved the performance of the Trichoderma microbe, which resulted in enhanced plant growth.

### Example 4

### Effects of Microbial Activator on Bacillus Strain

In this example, a Bacillus substilis microbe supplemented with different microbial activators was applied to tomato seedlings in a pot test to show its effectiveness. The experimental set up was similar to that described in Example 1. Table 6 summarizes the composition of various activator formulations used in this example, which included yeast autolysates, humic powder and micronutrients.

TABLE 6
Composition of Activator Formulations on Bacillus substilis

| | Substrate (g/pot) | | | |
|---|---|---|---|---|
| | | Yeast | Humic | |
| Treatment # | Microbes | Autolysates | Powder | Micronutrient |
| P2 | 0.5 | — | — | — |
| P5 | 0.5 | 0.2 | — | — |
| P6 | 0.5 | — | 8 | — |
| P7-4 | 0.5 | 0.2 | 4 | — |
| P7-8 | 0.5 | 0.2 | 8 | — |
| P8 | 0.5 | 0.2 | 4 | 0.05 |
| P9 | 0.5 | — | — | 0.05 |

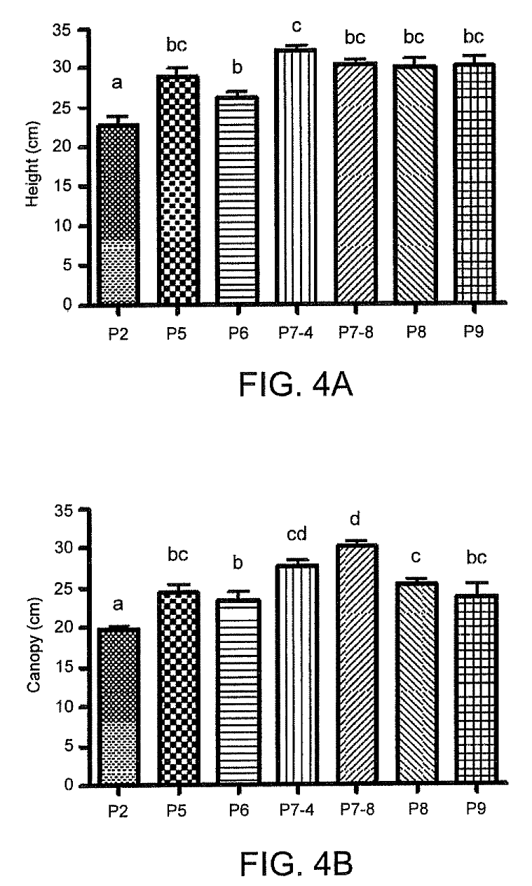

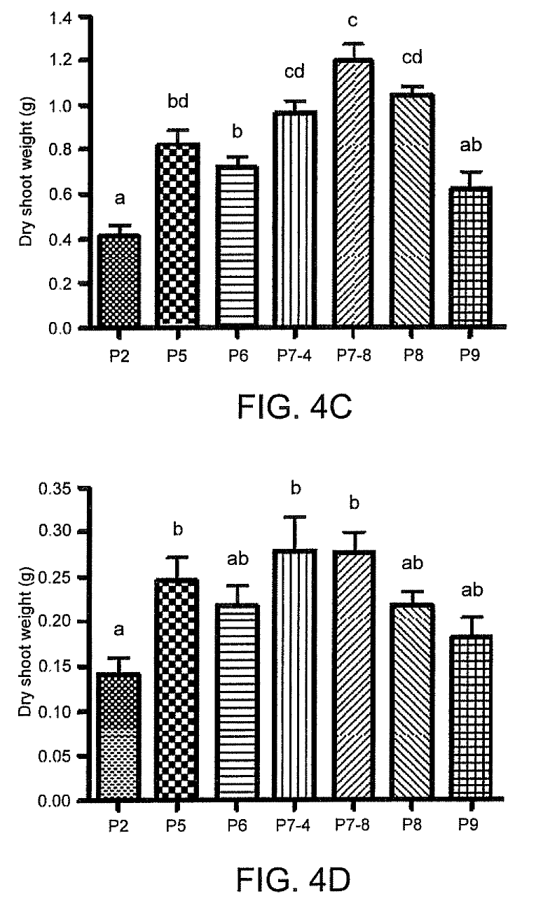

Plant height, canopy, dry shoot weight and dry root weight were measured at day 21, as depicted in FIGS. 4A to 4D. As shown, microbes supplemented with yeast autolysates, humic powder, and/or micronutrients (Treatments P5, P6, P7-4, P7-8, P8 and P9) exhibited significantly higher values in terms of plant height, canopy, dry shoot weight and dry root weight than did the treatment with the microbes alone (Treatment P2).

Consequently, this example indicated that the selected microbial activator formulations significantly improved the performance of the Bacillus substilis microbe, which resulted in enhanced plant growth.

### Example 5

### Effects of Microbial Activator on Microbial Blend

In this example, the selected microbial blend supplemented with different microbial activators was applied to tomato seedlings in a pot test to show its effectiveness. The experimental set up was similar to that described in Example 2. The microbial activator at five formulations, i.e., 10⁴ microbes+formulation 1 (F1), 10⁴ microbes+formulation 2 (F2), 10⁴ microbes+formulation 3 (F3), 10⁴ microbes+formulation 4 (F4), 10⁴ microbes+formulation 5 (F5), were added to the potting mix before transplant of the tomato seedlings. Table 7 summarizes the composition of activator formulations used in this example, which included yeast autolysates, humic powder and micronutrients.

TABLE 7
Composition of Activator Formulations on Microbial Blend

| | Substrate (g/pot) | | | |
|---|---|---|---|---|
| | | Yeast | Humic | |
| Treatment # | Microbes | Autolysates | Powder | Micronutrient |
| M3 | 0.5 | — | — | — |
| F1 | 0.5 | 0.2 | — | — |
| F2 | 0.5 | — | 8 | — |
| F3 | 0.5 | — | — | 0.05 |
| F4 | 0.5 | 0.2 | 4 | — |
| F5 | 0.5 | 0.1 | 8 | — |

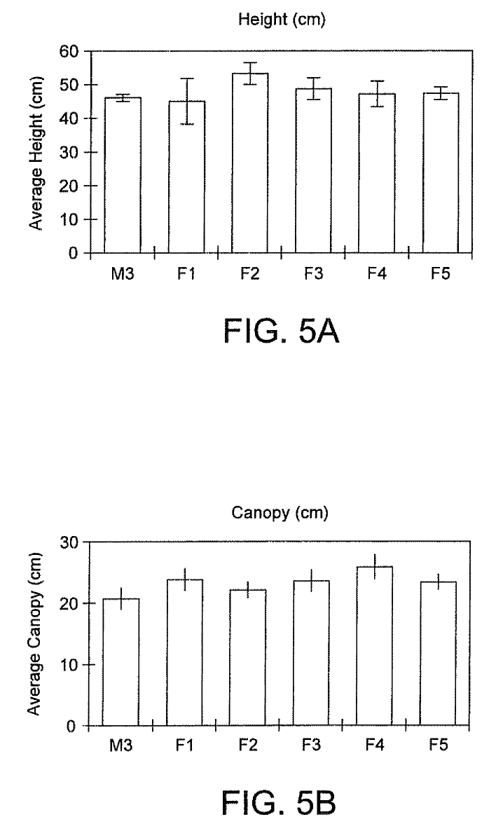

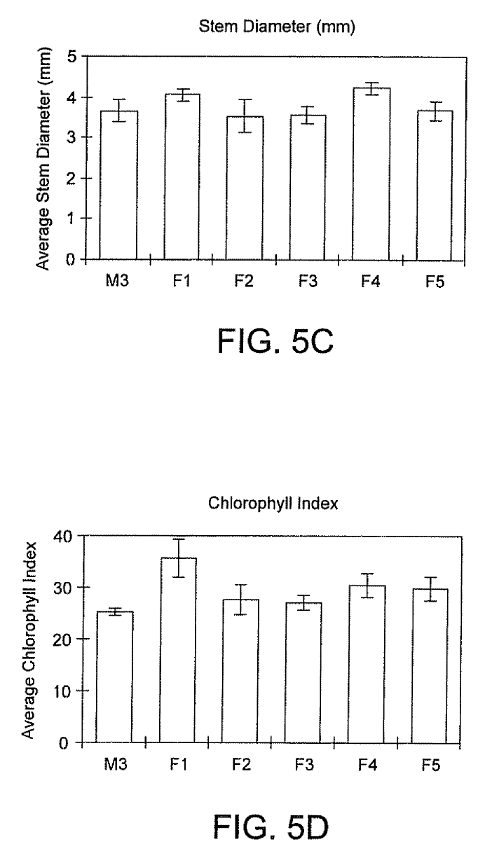

Plant height, canopy, stem diameter and chlorophyll index were measured at day 41, recorded in Tables 8 to 11 and depicted in FIGS. 5A to 5D. As shown in FIGS. 5B and 5D, microbial blend supplemented with yeast autolysates, humic powder, and/or micronutrients (F1, F3, F4 and F5) exhibited significantly higher values in terms of canopy and chlorophyll index than did the composition with the microbial blend alone (M3). As shown in FIG. 5A, the microbial blend supplemented with humic powder and micronutrients (F2 and F3, respectively) exhibited significantly higher values in terms of plant height than did the composition with the microbial blend alone (M3). As shown in FIG. 5C, microbial blend supplemented with yeast autolysates or yeast autolysates with humic powder (F1 and F4, respectively) exhibited significantly higher values in terms of stem diameter than did the composition with the microbial blend alone (M3).

Consequently, this example indicated that the selected microbial activator formulations significantly improved the performance of the microbial blend, which resulted in enhanced plant growth.

TABLE 8
Average height of plants at day 41 having applied a microbial
blend and various microbe activators

| | Height (cm) | | | | | | |
|---|---|---|---|---|---|---|---|
| Sample ID | #1 | #2 | #3 | #4 | #5 | Average | SD |
| M₃ | 46.0 | 45.5 | 45.5 | 45.5 | 48.0 | 46.1 | 1.1 |
| F₁ | 44.0 | 57.0 | 41.6 | 40.5 | 42.0 | 45.0 | 6.8 |
| F₂ | 54.3 | 55.5 | 54.2 | 55.0 | 47.5 | 53.3 | 3.3 |
| F₃ | 52.7 | 48.3 | 43.7 | 49.0 | 50.0 | 48.7 | 3.3 |
| F₄ | 46.0 | 45.0 | 53.0 | 43.3 | 48.5 | 47.2 | 3.8 |
| F₅ | 50.0 | 47.5 | 46.0 | 46.0 | — | 47.4 | 1.9 |

TABLE 9
Average canopy of plants at day 41 having applied a microbial
blend and various microbe activators

| | Canopy (cm) | | | | | | |
|---|---|---|---|---|---|---|---|
| Sample ID | #1 | #2 | #3 | #4 | #5 | Average | SD |
| M₃ | 18.5 | 19.5 | 21.5 | 23.0 | 21.0 | 20.7 | 1.8 |
| F₁ | 24.0 | 26.0 | 25.0 | 22.0 | 22.0 | 23.8 | 1.8 |
| F₂ | 21.0 | 23.0 | 20.5 | 22.5 | 23.5 | 22.1 | 1.3 |
| F₃ | 24.5 | 23.0 | 24.0 | 21.0 | 25.5 | 23.6 | 1.7 |
| F₄ | 26.0 | 26.6 | 24.5 | 23.5 | 28.7 | 25.9 | 2.0 |
| F₅ | 25.0 | 23.5 | 22.0 | 23.0 | — | 23.4 | 1.3 |

TABLE 10
Average stem diameter of plants at day 41 having applied a
microbial blend and various microbe activators

Stem (mm)

| Sample ID | #1 | #2 | #3 | #4 | #5 | Average | SD |
|---|---|---|---|---|---|---|---|
| M₃ | 3.4 | 3.8 | 3.7 | 4.0 | 3.3 | 3.7 | 0.3 |
| F₁ | 4.1 | 4.1 | 4.3 | 4.0 | 3.9 | 4.1 | 0.1 |
| F₂ | 4.0 | 3.9 | 3.1 | 3.4 | 3.2 | 3.5 | 0.4 |
| F₃ | 3.7 | 3.5 | 3.8 | 3.5 | 3.3 | 3.6 | 0.2 |
| F₄ | 4.2 | 4.1 | 4.3 | 4.4 | 4.1 | 4.2 | 0.1 |
| F₅ | 3.4 | 3.5 | 4.0 | 3.8 | — | 3.7 | 0.2 |

TABLE 11
Average chlorophyll index of plants at day 41 having applied a
microbial blend and various microbe activators

| | Chlorophyll Index | | | | | | |
|---|---|---|---|---|---|---|---|
| Sample ID | #1 | #2 | #3 | #4 | #5 | Average | SD |
| M₃ | 24.8 | 25.6 | 24.4 | 25.2 | 26.2 | 25.2 | 0.7 |
| F₁ | 37.0 | 38.7 | 37.4 | 29.4 | 35.9 | 35.7 | 3.7 |
| F₂ | 24.7 | 28.2 | 31.1 | 29.5 | 24.6 | 27.6 | 2.9 |
| F₃ | 28.8 | 27.5 | 27.2 | 27.0 | 24.9 | 27.1 | 1.4 |
| F₄ | 31.4 | 33.9 | 29.7 | 29.7 | 27.7 | 30.5 | 2.3 |
| F₅ | 27.7 | 31.0 | 32.5 | 28.1 | — | 29.8 | 2.3 |

### Example 6

### Application of the Composition to Upgrade an Organic Fertilizer (Mill Mud)

In this example, four samples were tested: two organic fertilizer samples of mill mud (FV-Mill Mud and FC-Mill Mud) and two samples of organic fertilizer of mill mud with plant growth promoting composition (FV-NS-1 and FC-NS-1S). FV-NS-1 comprised 1.5% of microbial blend, 2% of yeast autolysates and 96.5% of organic fertilizer, which included 60% of FV-Mill Mud and 36.5% of filler. FV-NS-1S comprised 1.5% of microbial blend, 2% of yeast autolysates and 96.5% of organic fertilizer, which included 60% of FC-Mill Mud and 36.5% of filler.

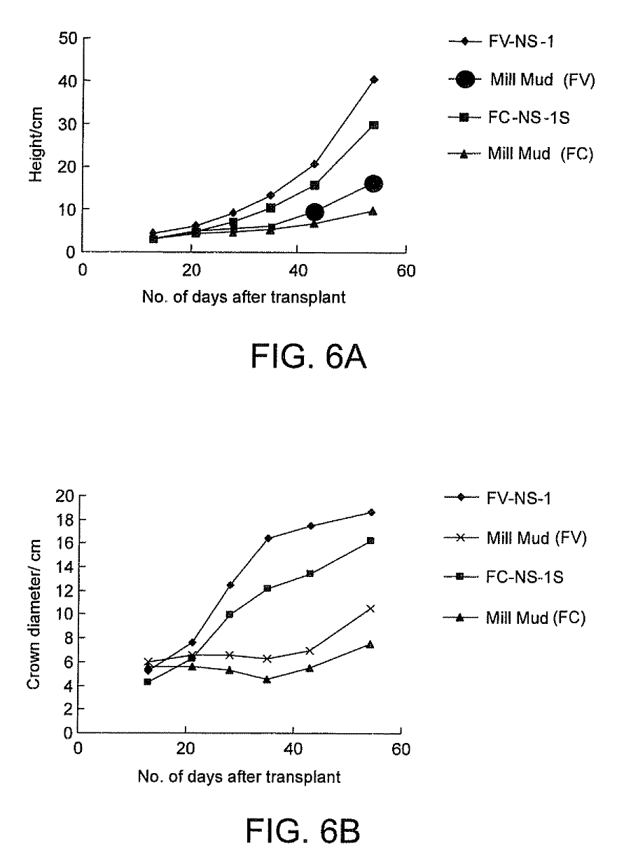

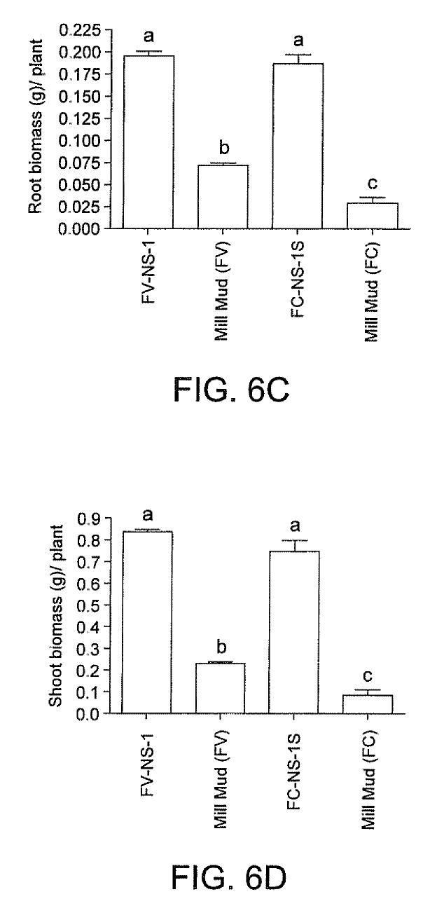

Plant height and crown diameter of the samples were measured every seven days until day 56, as depicted in FIGS. 6A and 6B. As shown, the samples of the organic fertilizer of mill mud with the plant growth promoting composition (FV-NS-1 and FC-NS-1S) exhibited significantly higher values in terms of plant height and crown diameter than did the samples of the organic fertilizer of mill mud alone (FV-Mill Mud and FC-Mill Mud).

Root biomass and shoot biomass of the samples were measured at day 69, as depicted in FIGS. 6C and 6D. As shown, the samples of the organic fertilizer of mill mud with the plant growth promoting composition (FV-NS-1 and FC-NS-1S) exhibited significantly higher values in terms of root biomass and shoot biomass than did the samples of the organic fertilizer of mill mud alone (FV-Mill Mud and FC-Mill Mud).

Consequently, this example indicated that the plant growth promoting composition significantly enhanced the fertility of organic fertilizer such as mill mud.

### Example 7

### Effect of Composition with Chemical Fertilizer

In this example, the composition containing both the microbial blend as used in Example 2 and the microbial activator was used to manufacture various mixture fertilizer products. A composition of the mixture fertilizer products included microbial blend, microbial activator, organic fertilizer, nitrogen chemical fertilizer, phosphate chemical fertilizer, and potassium chemical fertilizer. The mixture fertilizer product was manufactured using the process shown in FIGS. 9A and 9B.

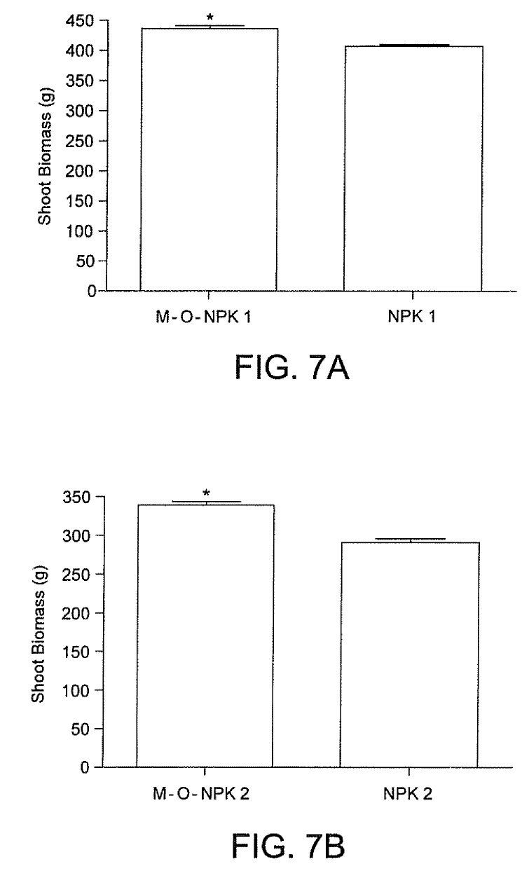

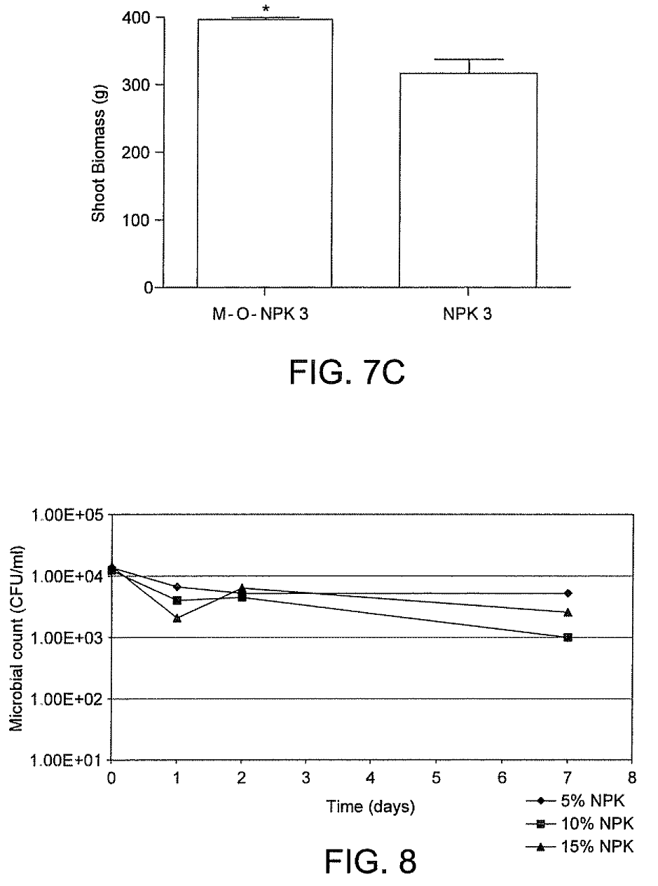

In this example, baby Chinese cabbage was used in six samples tested by a pot-test. Table 12 summarizes the sample descriptions and compositions. Shoot biomass was measured at harvest time, as depicted in FIGS. 7A to 7C. As shown, the samples of the plant growth promoting composition with the microbial blends, microbial activator and organics (M-O-NPK1, M-O-NPK2 and M-O-NPK3)) exhibited significantly higher values in terms of shoot biomass than the samples with the chemical fertilizers alone (NPK1, NPK2 and NPK3).

Consequently, this example indicated that the plant growth promoting composition and organics significantly enhanced the efficacy of chemical fertilizer.

TABLE 12
Summary of Samples and their Compositions

| | |
|---|---|
| M-O-NPK1 | Mixture of microbes, activator, organic compounds and |
| | NPK1 |
| NPK1 | Chemical fertilizer 1 includes urea, ammonium sulfate, |
| | MAP, potassium sulfate |
| M-O-NPK2 | Mixture of microbes, activator, organic compounds and |
| | NPK2 |
| NPK2 | Chemical fertilizer 2 includes urea, ammonium chloride, |
| | MAP, calcium superphosphate, potassium chloride |
| M-O-NPK3 | Mixture of microbes, activator, organic compounds and |
| | NPK3 |
| NPK3 | Chemical fertilizer 3 includes urea, ammonium chloride, |
| | MAP, calcium superphosphate, potassium chloride |

### Example 8

### Stability of Microbial Blend with Chemical Fertilizer

In this example, a test was performed to show the stability of a microbial blend when used in a chemical fertilizer solution. The microbial blend was added into an NPK fertilizer solution, and the microbial count was monitored over time. As shown in FIG. 8, no significant decrease in the microbial count was observed, which suggested that the use of selected microbes with chemical fertilizers is commercially feasible.

While the examples of the plant growth promoting composition have been described, it should be understood that the composition, and methods of making and using the composition, are not so limited, and modifications may be made. The scope of the plant growth promoting composition is defined by the appended claims, and all compositions and methods that come within the meaning of the claims, either literally or by equivalence, are intended to be embraced therein.

### REFERENCES

Almas Zaidi and Mohammad Saghir Khan (2005) Co-inoculation Effects of Phosphate Solubilizing Microorganisms and Glomus fasciculatum on Green Gram-Bradyrhizobium Symbiosis. Turk J Agric For 30: 223-230.

Altomare C, Norvell W A, Bjorkman T, Harman G E (1999) Solubilization of phosphates and micronutrients by the plant-growth promoting and biocontrol fungus Trichoderma Harzianum Rifai strain 1295-22 Appl Environ Microbial 65: 2926-2933

Elad, Y., and Kapat, A. (1999) The role of Trichoderma harzianum protease in the biocontrol of Botrytis cinerea. Eur. J. Plant Pathol. 105:177-189.

Francisco J. CEJUDO and Antonio PANEQUE (1986). Short-term Nitrate (Nitrite) Inhibition of Nitrogen Fixation in Azotobacter chroococcum. Journal of Bacteriology 165 240-243.

Grau, F. H. and Wilson, P. W. (1962) Physiology of nitrogen fixation by Bacillus polymyxa. Journal of Applied Chemistry and Biotechnology 83, 490-496.

Holl, F. B., Chanway, C. P., Turkington, R. and Radley, R. A. (1988) Response of crested wheat grass (Agropyron cristatum L.), perennial ryegrass (Lolium perenne L.) and white clover (Trifolium repens L.) to inoculation with Bacillus polymyxa. Soil Biology and Biochemistry 20, 19-24.

Howell, C. R., Hanson, L. E., Stipanovic, R. D., and Puckhaber, L. S. 2000. Induction of terpenoid synthesis in cotton roots and control of Rhizoctonia solani by seed treatment with Trichoderma virens. Phytopathology 90:248-252.

Johannes Zeidler, Brian G. Sayer, and Ian D. (2003a) Biosynthesis of Vitamin B₁ in Yeast. Derivation of the Pyrimidine Unit from Pyridoxine and Histidine. Intermediacy of Urocanic Acid. Spenser J. Am. Chem. Soc. 125(43): 13094-13105). Johannes Zeidler, Ram Nath Gupta, Brian G. Sayer, and Ian D. Spenser (2003b) Biosynthesis of Vitamin B₆ in Yeast. Incorporation Pattern of Trioses. J. Org. Chem. 68(9): 3486-3493.

Seldin, L., van Elsas, J. D. and Penido, E. G. C. (1983) Bacillus nitrogen fixers from Brazilian soils. Plant and Soil 70, 243-255.

Toro M, Azcón R, Barea J M. (1998) The use of isotopic dilution techniques to evaluate the interactive effects of Rhizobium genotype, mycorrhizal fungi, phosphate-solubizing rhizobacteria and rock phosphate on nitrogen and phosphorus acquisition by Medicago sativa. New Phytologist 138, 265-273.

Watanabe K, Sakai J, Hayano K. (2003) Bacterial extracellular protease activities in field soils under different fertilizer managements Can J Microbiol. 49(5):305-12.

Yedidia, I., Benhamou, N., and Chet, I. 1999. Induction of defense responses in cucumber plants (Cucumis sativus L.) by the biocontrol agent Trichoderma harzianum. Appl. Environ. Microbiol. 65:1061-1070.

We claim:

1. A plant growth promoting composition, comprising:
beneficial microbes; and
microbial activators,
wherein said beneficial microbes are selected from the group consisting of Bacillus spp., Azotobacter spp., Trichoderma spp., Saccharomyces spp., and combinations thereof.

2. The composition of claim 1, wherein said beneficial microbes are selected from the group consisting of Bacillus polymyxa, Bacillus subtilis, Azotobacter chroococcum, Trichoderma harzianum, Saccharomyces cerevisiae, and combinations thereof.

3. The composition of claim 1, wherein said microbial activators are selected from the group consisting of enzyme precursors, microbial metabolites, organic acid, carbohydrate, enzymes, and combinations thereof.

4. The composition of claim 1, wherein said microbial activators are selected from the group consisting of processed yeast product, humic material, seaweed extract, starch, amino acids, and combinations thereof.

5. The composition of claim 4, wherein said processed yeast product comprises yeast autolysates.

6. The composition of claim 4, further comprising a trace element selected from the group consisting of Zn, Cu, Mn, B, and Mo.

7. The composition of claim 1, wherein said beneficial microbes comprise from 1 to 50 weight percent of said composition.

8. The composition of claim 7, wherein said beneficial microbes comprise from 1 to 20 weight percent of said composition.

9. The composition of claim 8, wherein said beneficial microbes comprise from 1 to 10 weight percent of said composition.

10. The composition of claim 1, further comprising an organic fertilizer.

11. The composition of claim 10, wherein said organic fertilizer is selected from the group consisting of manure compost, raw manure, organic wastes, and combinations thereof.

12. The composition of claim 10, wherein said beneficial microbes comprise from 1 to 20 weight percent of said composition, said microbial activators comprise from 5 to 50 weight percent of said composition, and said organic fertilizer comprises from 30 to 94 weight percent of said composition.

13. The composition of claim 12, wherein said beneficial microbes comprise from 1 to 10 weight percent of said composition, said microbial activators comprise from 10 to 40 weight percent of said composition, and said organic fertilizer comprises from 50 to 89 weight percent of said composition.

14. The composition of claim 13, wherein said beneficial microbes comprise from 1 to 5 weight percent of said composition, said microbial activators comprise from 25 to 35 weight percent of said composition, and said organic fertilizer comprises from 60 to 74 weight percent of said composition.

15. The composition of claim 10, further comprising a chemical fertilizer.

16. The composition of claim 15, wherein said chemical fertilizer is selected from the group consisting of urea, calcium phosphate, potassium phosphate, blended NPK fertilizers, and combinations thereof.

17. The composition of claim 15, wherein said beneficial microbes comprise from 0.1 to 10 weight percent of said composition, said microbial activators comprise from 2 to 50 weight percent of said composition, said organic fertilizer comprises from 5 to 92.9 weight percent of said composition, and said chemical fertilizer comprises from 5 to 92.9 weight percent of said composition.

18. The composition of claim 17, wherein said beneficial microbes comprise from 0.1 to 5 weight percent of said composition, said microbial activators comprise from 5 to 50 weight percent of said composition, said organic fertilizer comprises from 10 to 89.9 weight percent of said composition, and said chemical fertilizer comprises from 5 to 84.9 weight percent of said composition.

19. The composition of claim 18, wherein said beneficial microbes comprise from 0.1 to 5 weight percent of said composition, said microbial activators comprise from 5 to 40 weight percent of said composition, said organic fertilizer comprises from 10 to 74.9 weight percent of said composition, and said chemical fertilizer comprises from 20 to 84.9 weight percent of said composition.

20. The composition of claim 1, wherein said composition is in a form selected from the group consisting of a powder, a granule, a pellet, and a liquid.

21. A method of making a plant growth promoting composition, comprising:
grinding and mixing raw materials;
drying said ground and mixed raw materials at a temperature of from 80 to 300° C. to form granulation products;
mixing said granulation products with microbes and molasses; and
forming said composition by drying said mixed granulation products at a temperature no higher than 80° C.

22. A method of promoting plant growth, comprising
applying a plant growth promoting composition,
wherein said plant growth promoting composition comprises beneficial microbes and microbial activators, and wherein said beneficial microbes are selected from the group consisting of Bacillus spp., Azotobacter spp., Trichoderma spp., Saccharomyces spp., and combinations thereof.

23. The method of claim 22, wherein said beneficial microbes are selected from the group consisting of Bacillus polymyxa, Bacillus subtilis, Azotobacter chroococcum, Trichoderma harzianu, Saccharomyces cerevisiae, and combinations thereof.

24. The method of claim 22, wherein said microbial activators are selected from the group consisting of yeast autolysates, humic powder, seaweed extract, starch, amino acids and combinations thereof.

25. The method of claim 22, wherein said plant growth promoting composition further comprises an organic fertilizer.

26. The method of claim 25, wherein said organic fertilizer is selected from the group consisting of manure compost, raw manure, organic wastes, and combinations thereof.

27. The method of claim 25, wherein said plant growth promoting composition further comprises a chemical fertilizer.

28. The method of claim 27, wherein said chemical fertilizer is selected from the group consisting of urea, calcium phosphate, potassium phosphate, blended NPK fertilizers, and combinations thereof.
